(19) United States
(12) Patent Application Publication
(10) Pub. No.: US 2018/0017684 A1
(43) Pub. Date: Jan. 18, 2018

(54) ARTICULATED SEGMENTED X-RAY DETECTOR SYSTEM AND METHOD

(71) Applicant: Teledyne DALSA, Inc., Waterloo (CA)

(72) Inventors: Bryan DELODDER, Guelph (CA); Andrey LOMAKO, Waterloo (CA); Peter GOOSSENS, Waterloo (CA)

(21) Appl. No.: 15/546,948

(22) PCT Filed: Dec. 22, 2015
(86) PCT No.: PCT/CA2015/051363

§ 371 Date: Jul. 27, 2017

Related U.S. Application Data
(60) Provisional application No. 62/112,971, filed on Feb. 6, 2015.

(51) Int. Cl. G01T 1/24; G01N 23/04; G01S 19/13

(52) U.S. Cl. CPC G01T 1/24; G01N 23/04; G01S 19/13; G01N 2223/5015

(57) ABSTRACT

A system, method and an apparatus are provided for imaging a target object, such as, e.g. a pipeline or aircraft, and may include an articulated segmented x-ray detector comprising a plurality of individual x-ray detector segments, which may be CMOS detectors or other type of semiconductor detector, articulately connected to one another. The articulately connections permit rotation of each x-ray detector segments which also permits conformity to the shape of a target object. A camera controller may be connected to each of the plurality of individual x-ray detector segments for receiving image data from each individual x-ray detectors. A flexible mat containing x-ray blocking objects may be connected to the articulated segmented x-ray detector to provide reference potions in the image data and for use in processing the image data.

### BACKGROUND OF THE DISCLOSURE

### 1.0 Field of the Disclosure

The disclosure is directed generally to a system and method for an articulated segmented x-ray detector and, more particularly, to a system and method for an articulated multiple x-ray detector segments that may be flexibly configured about an object to be x-rayed.

### 2.0 Related Art

Currently, flexible x-ray film is typically employed in applications requiring the use of x-rays for diagnostic purposes such as, e.g., inspection of metals or welds in pipelines. Surfaces employing welds, such as, e.g., a pipeline, are typically inspected by applying x-ray film on the outside of the pipeline with the source of x-rays either inside the pipeline or opposite the x-ray film on the opposing side of the pipeline. Analog type x-ray film is typically expensive, inconvenient and requires development time before results can be accessed. X-ray film is usually limited in sensitivity and dynamic range. There are digital prototypes but their performance are spoor and difficult to use or improve.

Other types of solutions may employ a motorized detector rotating around the pipeline but have very narrow windows and, therefore, do not benefit from all of the x-ray flux from the generator of the x-rays because much of the x-rays are wasted due to being collimated to image the narrow window. This often causes signal-to-noise and exposure time problems. Moreover, the scans often take a significant amount of time to perform. Additionally, the image quality may be degraded by x-ray shot noise.

### SUMMARY OF THE INVENTION

In one aspect, a system for imaging a target object is provided. The system may include an articulated segmented x-ray detector comprising a plurality of individual x-ray detector segments articulately connected to one another, a camera controller configured to be connected to each of the plurality of individual x-ray detector segments for communicating with and receiving image data from each individual x-ray detector; and a x-ray source for producing x-rays to create an image of the target object at the articulated segmented x-ray detector. The plurality of individual x-ray detector segments are pivotally connected to an adjacent individual x-ray detector segment to permit rotation with respect to one another and to conform to a shape of the target object. The plurality of individual x-ray detector segments may overlap. Each of the plurality of individual x-ray detector segments may comprise a semiconductor based detector. The system may further comprise a flexible mat configured to hold the articulated segmented x-ray detector against the target object. The flexible mat may include a plurality of x-ray blocking material arranged in a pattern.

In one aspect, an apparatus for imaging an object is provided. The apparatus may comprise an articulated segmented x-ray detector comprising a plurality of individual x-ray detector segments articulately connected to one another to permit rotation with respect to one another, wherein one individual x-ray segment overlaps with an adjacent individual x-ray segment and a camera controller configured to be connected to each of the plurality of individual x-ray detector segments for communicating with and for receiving image data. The apparatus may further comprise a flexible mat connected to the articulated segmented x-ray detector and configured with a plurality of x-ray blocking objects for providing a reference in a captured image. The plurality of individual x-ray detector segments may each comprise a semiconductor based detector. The camera controller may be configured to be articulately connected to one of the individual x-ray detector segments.

In one aspect, a method of imaging a target object is provided. The method including the steps of connecting a plurality of individual x-ray detector segments to one another to create an articulated segmented x-ray detector, wherein the plurality of individual x-ray detector segments are rotatable with respect to one another, and connecting a camera controller to each of the plurality of individual x-ray detector segments for receiving image data from each individual x-ray detector segment and providing a x-ray source for producing x-rays to create an image of the target object at the articulated segmented x-ray detector. The step of connecting a plurality of individual x-ray detector segments may include pivotally connecting plurality of individual x-ray detector segments to an adjacent individual x-ray detector segment to permit rotation with respect to one another and for conforming to a shape of the target object. The connecting a plurality of individual x-ray detector segments step may include overlapping the plurality of individual x-ray detector segments. The plurality of individual x-ray detector segments may each comprise a semiconductor detector. The plurality of individual x-ray detector segments may each comprise a CMOS detector or a TFT detector. The method may further comprise processing a received image data from each individual x-ray detector using the reference points in the received image data to compensate for any stretching or compressing in the received image data to create a final composite image. The step of connecting a camera controller to each of the plurality of individual x-ray detector segments may permit communication between the camera controller and the plurality of individual x-ray detector segments including control data. This communication may be accomplished by a wired or wireless connection.

Additional features, advantages, and examples of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the invention. No attempt is made to show structural details of the disclosure in more detail than may be necessary for a fundamental understanding of the disclosure and the various ways in which it may be practiced. In the drawings:

FIG. 1 is an example illustration of an articulated segmented x-ray detector, configured according to principles of the disclosure;

FIG. 2 is an example perspective view illustration showing an alternate shape of a flexible mat, configured according to principles of the disclosure;

FIG. 3 is an example bottom perspective view of an individual x-ray detector, with part of the bottom side of the housing cut-away, configured according to principles of the disclosure;

FIG. 4 is an illustration of individual detectors being configured about a target object to be x-rayed, configured according to principles of the disclosure;

FIG. 5 is an illustration of an example flexible mat, configured according to principles of the disclosure;

FIGS. 6A-6D are an illustration of different shapes of target objects and positioning of individual detectors 105a-105c of the articulated segmented x-ray detector 100, configured according to principles of the disclosure;

FIGS. 7A-7D are an illustration of the relative position of an x-ray source 165 in relation to individual detectors 105a-105c of the articulated segmented x-ray detector 100, configured according to principles of the disclosure;

FIG. 8 is an illustration showing x-ray sources at differing locations in relation to a target object, according to principles of the disclosure;

FIG. 9 is an illustration showing patterns formed on an x-ray image due to x-ray blocking material in or on the flexible mat, according to principles of the disclosure;

FIG. 10 shows an example illustration of a portion of a flexible mat that shows an example of a pattern of x-ray blocking objects acting as markers in an image, configured according to principles of the disclosure;

FIG. 11 is a cut-away view of an example of an articulated segmented x-ray detector, configured according to principles of the disclosure;

FIG. 12 is a close-up view of a cut-away portion of FIG. 11.

FIG. 13 is an example illustration showing a daisy-chain configuration among the plurality of individual detectors, configured according to principles of the disclosure;

FIG. 14 is an example illustration showing a parallel type configuration between the plurality of individual detectors and the camera controller, configured according to principles of the disclosure; and

FIG. 15 is an example illustration showing a star type configuration between the plurality individual detectors and the camera controller, configured according to principles of the disclosure.

### DETAILED DESCRIPTION OF THE INVENTION

It is understood that the disclosure is not limited to the particular methodology, protocols, etc., described herein, as these may vary as the skilled artisan will recognize. It is also to be understood that the terminology used herein is used for the purpose of describing particular examples only, and is not intended to limit the scope of the disclosure. It is also to be noted that as used herein and in the appended claims, the singular forms “a,” “an,” and “the” include the plural reference unless the context clearly dictates otherwise.

Unless otherwise defined, all technical and scientific terms used herein have the same meanings as commonly understood by one of ordinary skill in the art to which the disclosure pertains. The examples of the disclosure and the various features and advantageous details thereof are explained more fully with reference to the non-limiting examples that are described and/or illustrated in the accompanying drawings and detailed in the following description. It should be noted that the features illustrated in the drawings are not necessarily drawn to scale, and features of one example may be employed with other examples as the skilled artisan would recognize, even if not explicitly stated herein. Descriptions of well-known components and processing techniques may be omitted so as to not unnecessarily obscure the examples of the disclosure. The examples used herein are intended merely to facilitate an understanding of ways in which the disclosure may be practiced and to further enable those of skill in the art to practice the examples of the disclosure. Accordingly, the examples herein should not be construed as limiting the scope of the invention, which is defined solely by the appended claims and applicable law. Moreover, it is noted that like reference numerals reference similar parts throughout the several views of the drawings.

A “computer”, as used in this disclosure, means any machine, device, circuit, component, or module, or any system of machines, devices, circuits, components, modules, or the like, which is (are) capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link. The electronic device may include, for example, but is not limited to, a mobile telephone, a personal data assistant (PDA), a mobile computer, a stationary computer, a smart phone, mobile station, user equipment, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “network,” as used in this disclosure, means an arrangement of two or more communication links. A network may include, for example, the Internet, a local area network (LAN), a wide area network (WAN), a metropolitan area network (MAN), a personal area network (PAN), a campus area network, a corporate area network, a global area network (GAN), a broadband area network (BAN), any combination of the foregoing, or the like. The network may be configured to communicate data via a wireless and/or a wired communication medium. The network may include any one or more of the following topologies, including, for example, a point-to-point topology, a bus topology, a linear bus topology, a distributed bus topology, a star topology, an extended star topology, a distributed star topology, a ring topology, a mesh topology, a tree topology, or the like.

A “communication link” (or “communication links”), as used in this disclosure, means a wired and/or wireless medium that conveys data or information between at least two points. The wired or wireless medium may include, for example, a metallic conductor link, an air link, a fluid medium link, a radio frequency (RF) communication link, an Infrared (IR) communication link, an optical communication link, or the like, or any combination of the foregoing without limitation. The RF communication link may include, for example, WiFi, WiMAX, IEEE 802.11, DECT, 0G, 1G, 2G, 3G or 4G cellular standards, Bluetooth, or the like. The “communication link” may comprise a Universal Serial Bus (USB) such as e.g., USB3.

A “computer-readable medium”, as used in this disclosure, means any medium that participates in providing data (for example, instructions) which may be read by a computer. Such a medium may take many forms, including non-volatile media, non-transitory media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer-readable media may be involved in carrying sequences of instructions to a computer, including, e.g., a non-transitory form of computer-readable medium. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article Similarly, where more than one device or article is described herein, it will be readily apparent that a single device or article may be used in place of the more than one device or article. The functionality or the features of a device may be alternatively embodied by one or more other devices which are not explicitly described as having such functionality or features.

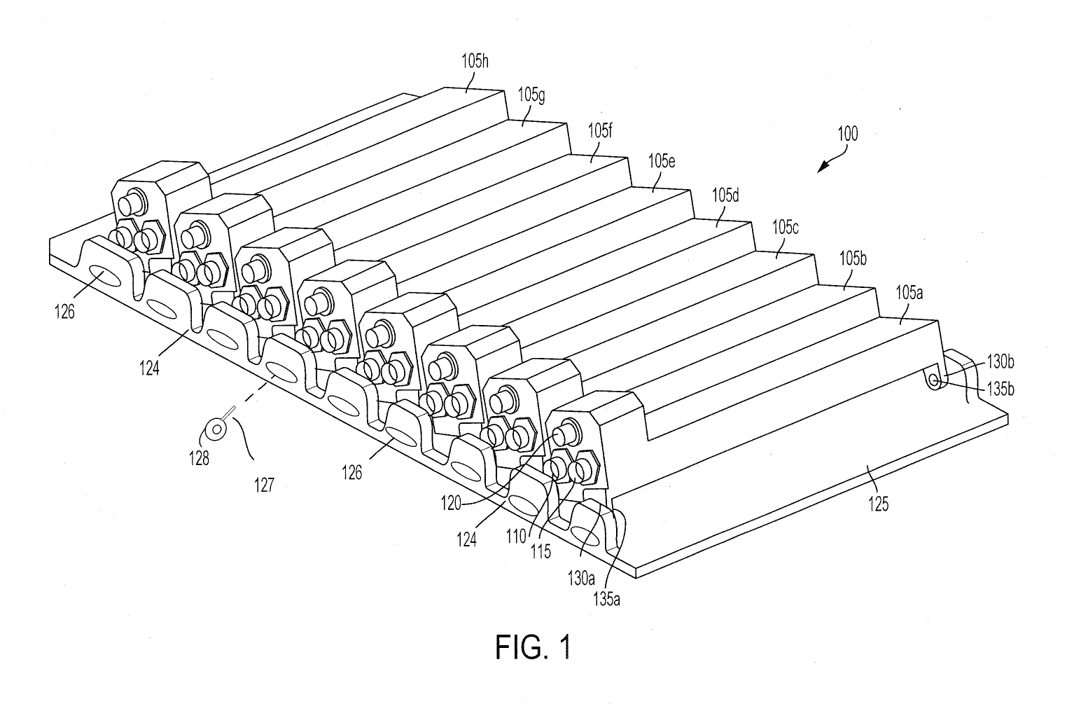

FIG. 1 is an example illustration of an articulated segmented x-ray detector, configured according to principles of the disclosure. The articulated segmented x-ray detector 100 may comprise a plurality of individual detectors 105a-105h. The plurality of individual detectors 105a-105h may comprise a semiconductor based x-ray detector section 161 (FIG. 3), which may be, e.g., a CMOS type detector section, amorphous silicon or glass thin film transistor (TFT). The CMOS section may be produced from, e.g., an 8″ or a 12″ wafer. The total number of individual detectors 105a-105h may vary in different implementations. The plurality of individual detectors 105a-105h may be configured to be connected to one another while also permitting the plurality of individual detectors 105a-105h to flexibly reposition themselves relative to one another to conform to a shape of a target object to be x-rayed (such as shown in FIG. 4). The plurality of individual detectors 105a-105h may be configured to overlap one another even when conforming to the shape of a target object 150 (FIG. 4) such as, e.g. a pipeline. The overlapping individual detectors 105a-105h configuration may result in the detector section 161 to be angled upwardly as shown in FIG. 1. The articulated segmented x-ray detector 100 may be used to perform various types of quality or integrity checks on target objects such as, e.g., determining the integrity of welds or other joining techniques. The articulated segmented x-ray detector 100 may image a target object for about 180 degrees, in one image. The articulated segmented x-ray detector 100 may image a target object for more or less than 180 degrees, in one image.

The individual detectors 105a-105h may be configured with one or more pegs or fingers 155a, 155b (FIG. 3) and mating holes 141 (FIG. 4) located at each opposite end of the individual detectors 105a-105h. The pegs 155a, 155b of one individual detector 105a-105h may be inserted into corresponding mating holes 141 of an adjacent individual detector 105a-105h. In this manner, the plurality of individual detectors 105a-105h may be connected in a constant relative position in reaction to an adjacent individual detector 105a-105h, while permitting rotation of each of the individual detectors 105a-105h, as needed, to conform to a shape of a target object being x-rayed. The individual detectors 105a-105h may be configured with a plurality of connection points 135a, 135b, 135c to connect with a flexible mat 125 at a plurality of corresponding connecting points 130a, 130b, that may be attached using a pin or connecting mechanism. Slots 126 may be configured in the side wall portions 124 (on each side of the flexible mat 125, second side not shown in FIG. 1) for permitting a plurality of retaining mechanisms 127 to engage the plurality of individual detectors 105a-105h thereby connecting the plurality of individual detectors 105a-105h to the flexible map 125. The retaining mechanism may be or include, e.g., a screw or other similar connecting device, which might further include a washer 128, anchor, sleeve, or peg type mechanism. The slots 126 may be of an oval type shape to permit the retaining mechanisms 127 to move in relation to the flexible mat 125 when the articulated segmented x-ray detector 100 is configured about a target object 150 to permit the individual detectors 105a-105h to realign in relation to one another (e.g., closer to or farther from one another) and the shape of target object 150, allowing for differences in curvature radius.

The individual detectors 105a-105h may include a housing 160 (FIG. 3). The housing 160 may comprise aluminum or other sturdy material that is sufficiently ruggedized to withstand potentially harsh use in the field when taking images of target objects 150 such as, e.g., pipelines. However, the bottom side 160 of the housing 160 next to the flexible mat 125 must be able to pass x-ray energy so that the x-ray detector section 161 can image a target object 150. This may require that the bottom side be made from a material that does not block x-rays. This bottom side may be, e.g., a graphite composite. Alternatively, the entire housing of the individual detectors 105a-105h may be made from a non-x-ray blocking material such as, e.g., a graphite composite, or similar material.

The individual detectors 105a-105h may be configured with a left data connector 110, a right data connector 115, and a power connector 120 for power, control and synchronization. The left data connector 110 may be may be employed to connect to a camera control box 210 (FIG. 14) that controls operations of the articulated segmented x-ray detector 100, or connected to the right data connector 115 of an adjacent individual detector 105b-105h creating, e.g., a daisy chain type of connection for a shared communication bus. The daisy chained left data connectors 110 and right data connectors 115 may be employed to convey image data from the individual detectors 105a-105h to the camera control box 210 when an image is taken. Alternatively, there may be fewer or more connectors 115, 110, 120 or different connectors depending on the type of communication link and communication topology being used. Other types of topologies are described more below.

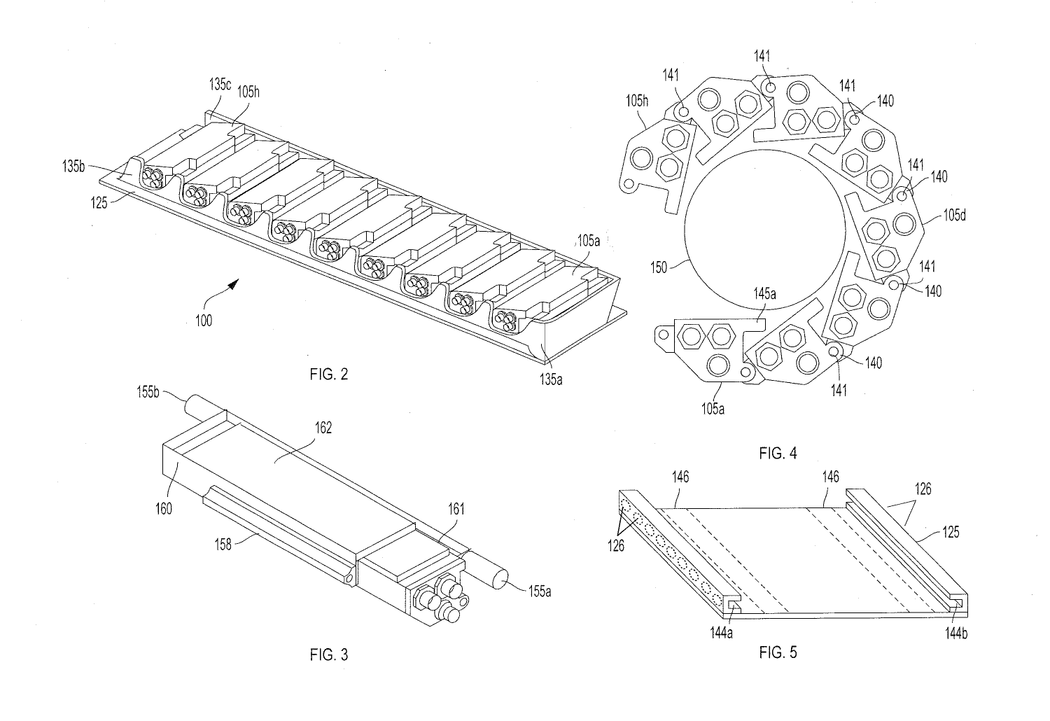

FIG. 2 is an example perspective view illustration showing an alternate shape of flexible mat 125. FIG. 3 is an example bottom perspective view of an individual detector, with part of the bottom side 162 of the housing 160 cut-away. The each individual detector 105 may comprise an x-ray detector section 161. A pair of pegs or fingers 155a, 155b for attaching to an adjacent individual detector 105a-h. The corresponding portion containing the mating holes 141 and connecting portion 140 is not shown in FIG. 3, but is shown in FIG. 4. A connecting portion 158 may be utilized to connect to the array of individual detectors 105a-105h to the flexible mat 125, and/or, alternatively, may be used to interconnect the array of individual detectors 105a-105h to one another in a similar manner as connecting portion 140 connects the array of individual detectors 105a-105h to one another.

FIG. 4 is an illustration of individual detectors 105a-105h being configured about a target object 150 to be x-rayed, without the flexible mat 125 shown so that the relationship of the individual detectors 105a-105h can be better seen, configured according to principles of the disclosure. The articulation capability of the individual detectors 105a-105h permits rotation about the pegs or fingers 155a, 155b which permits constant relative distance from one another while being rotated about the rotation point provided by the peg 155a, 155b and to permit conforming of the articulated segmented x-ray detector 100 to the shape of the target object 150. Since different target objects may have different circumferences and or contours, the articulated characteristic of segmented x-ray detector 100 permits general conformity to the shape of the target object 150. A finger 145a that may be configured on each individual detector 105a-105h may assist in maintaining the overlap of adjacent detectors. A flexible attaching means such as, e.g., a bungee cord, may connect to one or both ends of the articulated segmented x-ray detector 100 to secure the articulated segmented x-ray detector 100 to a target object 150. An x-ray source (not shown) may be positioned in the target object 150, or outside of the target object 150, as appropriate.

FIG. 5 is an illustration of an example flexible mat, configured according to principles of the disclosure. The flexible mat 125 may comprise, e.g., a plastic, carbon fiber, or composite material that does not block x-rays and has flexible properties for wrapping about a target object 150, while also being durable for potential harsh use in the field. The flexible mat 125 must be adequately capable of conforming to various shapes of target objects 150. The flexible mat 125 may also have some degree of gripping characteristics, such as found in a rubberized type material, to minimize slipping of the articulated segmented x-ray detector 100 while being placed in position about a target object 150. Moreover, the flexible mat 125 must be sufficiently strong to manage the overall weight of the plurality of individual detectors 105a-105h or 205a-205h. Slots 144a, 144b may be configured in a raised wall portion 143a, 143b along the sides of the flexible mat 125 for receiving the plurality of individual detectors 105a-105h or 205a-205h for assisting in securing them to the flexible mat 125. The flexible mat 125 of FIG. 5 may be considered a sliding-concept for connecting to the plurality of individual detectors 105a-105h or 205a-205h. Slots 126 may be configured in the wall portions 143a, 143b, similarly as described in relation to FIG. 1. The slots 126 may be oval shaped (or other similar shape) to receive one or more retaining mechanisms 127 to engage the plurality of individual detectors 105a-105h (205a-205h) for permitting the retaining mechanisms 127 to move in relation to the flexible mat 125 when the articulated segmented x-ray detector 100, 200 is configured about a target object 150 to permit the individual detectors 105a-105h (205a-205h) to realign in relation to one another and the shape of target object 150, allowing for differences in curvature radius. The flexible mat 125 may include a plurality of slots 126 to permit one or more retaining mechanisms 127 to slide laterally to permit the plurality of individual x-ray detector segments 105a-105h or 205a-205h to move laterally to conform to a curvature of the target object 150.

In FIG. 5, the areas 146 of the flexible mat 125 designates where one or more x-ray blocking objects 168 may be embedded and/or positioned to form a pattern in the flexible mat 125 to act as markers in images. The x-ray blocking objects 168 may be arranged so that they appear on either side of the target object's location of interest for x-raying. The x-ray blocking objects 168 may create an “x-ray water mark” in the resulting image. As shown in FIG. 10, the x-ray blocking objects 168 may be a material such as, e.g., tungsten, copper or similar x-ray blocking material arranged at known locations within or on the flexible mat 125 forming a known pattern which provides a reference in an image for eventual processing of images. The x-ray blocking object 168 may comprise different shapes and sizes, perhaps with alternating types of shapes/sizes that can be readily identified by image software processing. As shown in relation to FIG. 10, the pattern may comprise circular shapes, but the pattern may be other shapes such as diamonds, lines, or squares, and differing sizes, in any combination that permits by image software processing to identify the positions of the markers. The x-ray blocking object 168 may be configured and positioned with known distances between one another so that an image containing the patterns permits software processing to compensate for stretching and/or distortion of images due to any relative differences in x-ray source location to the individual detectors 105a-105h and/or relative differences in angles of the individual detectors 105a-105h due to the nature of the shape of the target object 150 to provide a mosaic fused into a single geometric corrected image.

FIG. 10 shows an example illustration of a portion of a flexible mat 125 that shows an example of a pattern of x-ray blocking objects 168 acting as markers in an image, configured according to principles of the disclosure. The x-ray blocking object 168 may be embedded or positioned at known locations in or on the flexible mat 125, with predetermined spacing (e.g., 1 cm, 2 cm, 3 cm or other spacing) from one another when forming patterns. Moreover, the markers may be configured in or on the flexible mat 125 so that a pre-determined number of the markers will be positioned in predetermined locations for each individual detector 105a-105h or 205a-205g. As showed in FIG. 10, the groups or pattern of x-ray blocking object 168 align with individual detectors 105a-105h or 205a-205g (detectors not shown in FIG. 10), represented by the boxes 169 formed by the dotted lines. In this example, four markers of x-ray blocking object 168 will align with a corresponding individual detector 105a-105h or 205a-205g, when the flexible mat 125 and individual detectors 105a-105h or 205a-205g assembled together. In this way, the markers provide a reference or a calibration in any resulting image captured by the individual detectors 105a-105h, permitting reconstruction and correction of stretching for a final image of the target object 150.

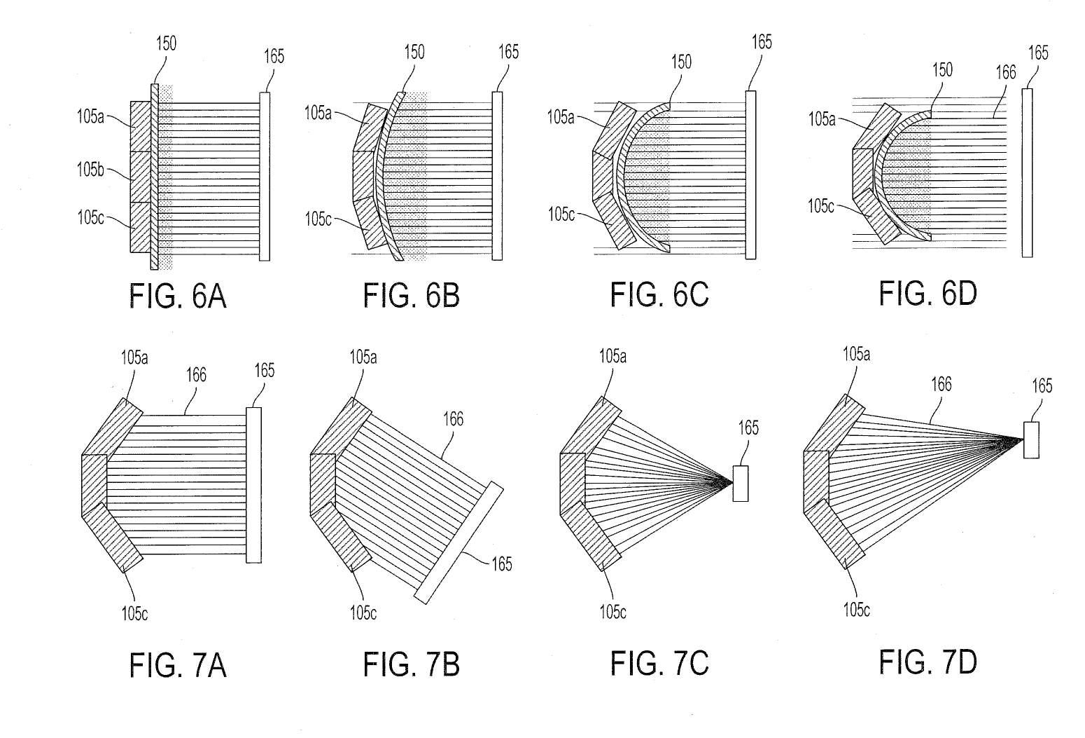

FIGS. 6A-6D is an illustration of different shapes of target objects and positioning of individual detectors 105a-105c of the articulated segmented x-ray detector 100, configured according to principles of the disclosure. The differing shape of the target object 150 in FIGS. 6A-6D changes from a flat orientation in FIG. 6A to an ever increasing amount of curvature to FIG. 6D. The orientation of the individual detectors 105a-105c, changes accordingly. The change in orientation of the individual detectors 105a-105c because of the shape differences, has an effect that leads to stretching of the captured x-ray image. This stretching effect can be corrected after imaging by suitable software, which may be accomplished at a camera controller 210, or other computer platform (e.g., computer 166) by software processing. The substantially parallel x-rays 166 represents an x-ray source 165 at a significant distance, but in different configurations, the distance might be closer.

FIGS. 7A-7D are an illustration of the relative position of an x-ray source 165 in relation to individual detectors 105a-105c of the articulated segmented x-ray detector 100, configured according to principles of the disclosure. This sequence illustrate that the relative position of then x-ray source 165 in relation to each of the individual detectors 105a-105c may also cause stretching of images captured by the articulated segmented x-ray detector 100. This effect may also be compensated by a camera imaging controller 210, or other computer platform 166 by software processing. The substantially parallel x-rays 166 represents an x-ray source 165 at a significant distance, but in different configurations, the distance might be closer.

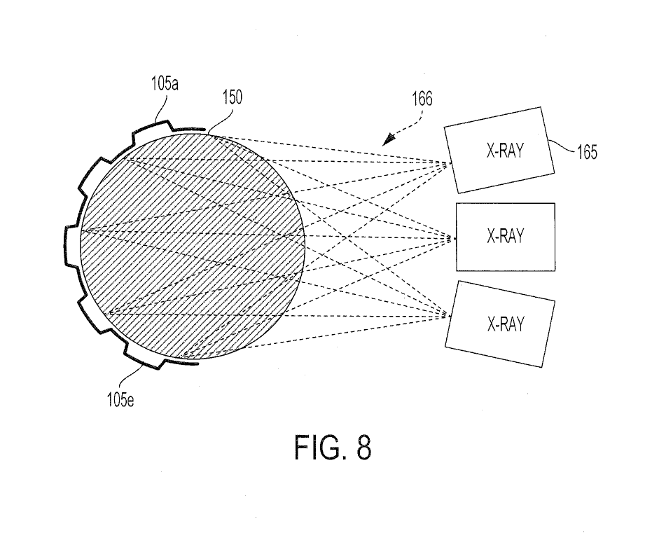

FIG. 8 shows an illustration showing x-ray sources at differing locations in relation to a target object, according to principles of the disclosure. As found in tomographic techniques, an x-ray source 165 may be located at different locations and the angle of the x-rays 166 in relation to the target object 150 and the detectors 105a, 105e may create differences in image quality at each detector 105a and 105e. The different locations of the x-ray source 165 may be captured by tomographic techniques and calculated using different geometric patterns created by the x-ray blocking objects 168 in flexible mat 125. This potential difference in image quality can be compensated for by software processing as discussed more below.

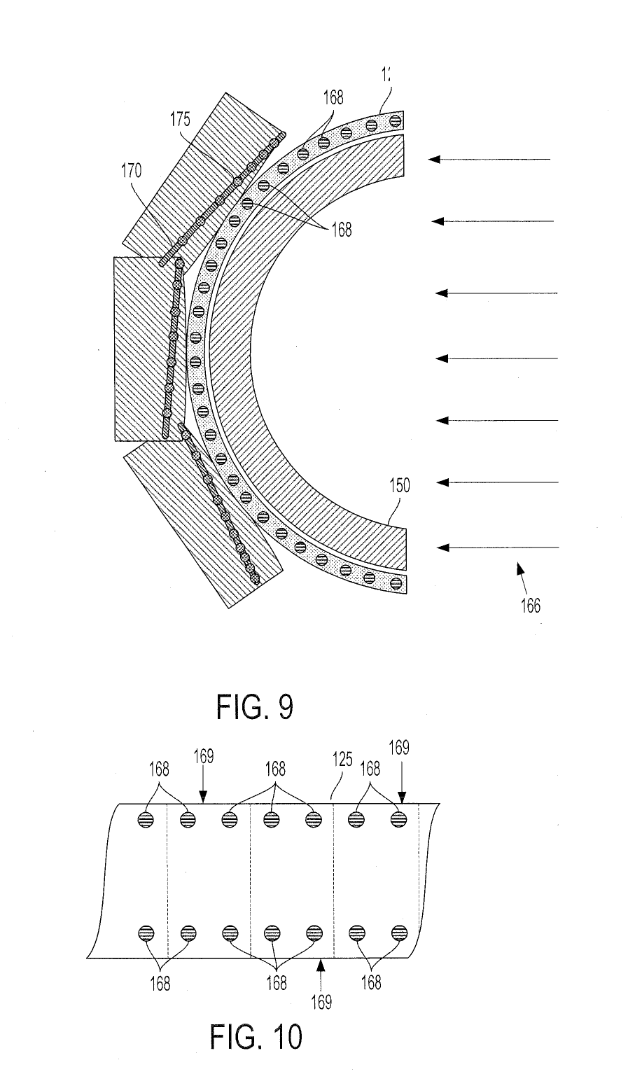

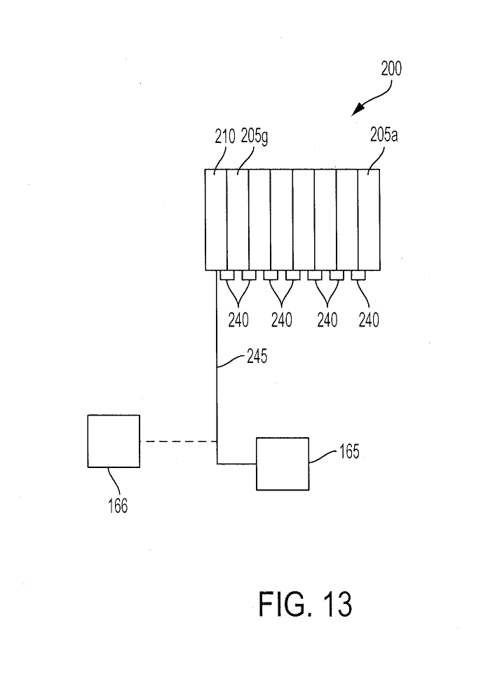

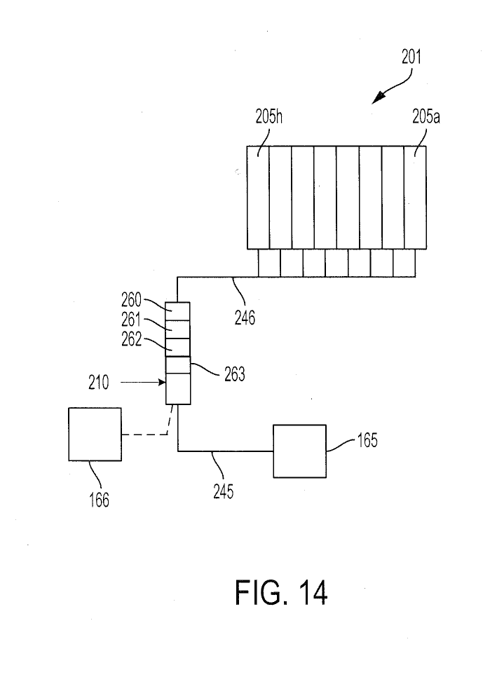

FIG. 9 is an illustration showing patterns formed on an x-ray image due to x-ray blocking material in or on the flexible mat, according to principles of the disclosure. The x-ray blocking object 168 in flexible mat 125 is shown arranged about the target object 150. The individual x-ray detectors 105a-105c (or 205a-205c) are shown with a captured image 170, having been exposed to an x-ray source 165 for imaging the target object 150. The x-ray source 165 may produce x-ray energy at about 40 to about 350 keV, but may vary. The x-rays are shown substantially parallel denoting that the x-ray source (not shown) may be at a considerable distance from the 105a-105c (or 205a-205c), but this is illustrative only, as the x-ray source may be at nearer distances. The locations of the x-ray blocking object 168 is captured in the image 170 represented by the image markers 175 in the image 170, in each of the individual x-ray detectors 105a-105c. As shown, the spacing of the image markers are not uniform in this example because of the location of the x-ray source and/or the relative angles of the individual detectors 105a-105c in relation to the x-ray souse, which is also related to the x-ray blocking object 168 in flexible mat 125. The image markers 175 provide a reference for correcting and reconstituting the actual image of the target object 150. Reconstruction of the final image may be accomplished by down loading the digital images from each individual detector 105a-105c to the camera controller 210 (FIGS. 13-15), which may perform the reconstruction to a final composite image, or the image data may be downloaded from the camera controller 210 to a computer 166 for further processing such as, e.g., correction and reconstruction to a final composite image.

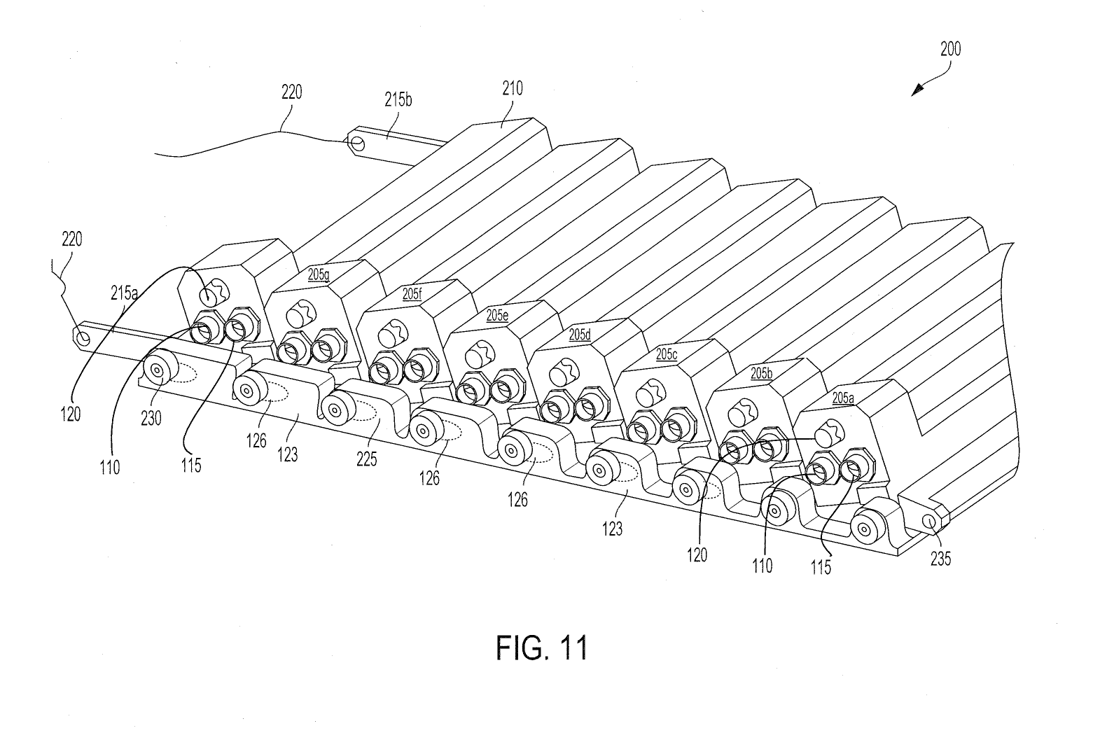

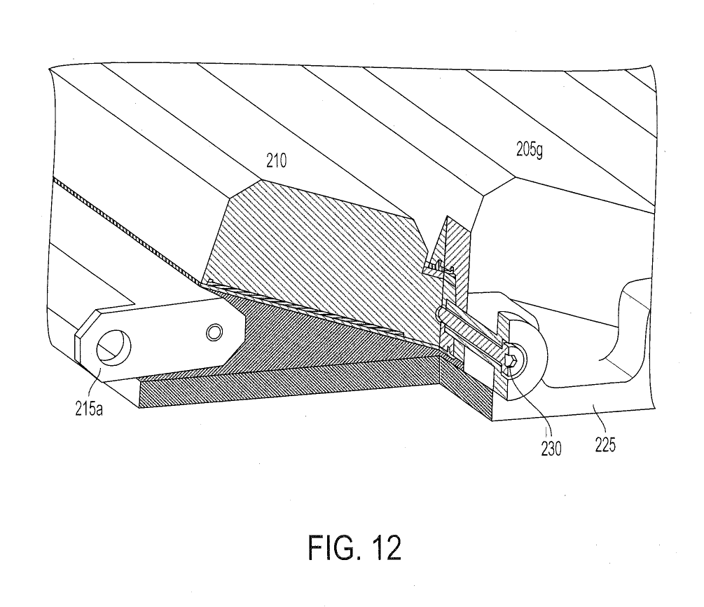

FIG. 11 is a cut-away view of an example of an articulated segmented x-ray detector, configured according to principles of the disclosure. FIG. 12 is a close-up view of a cut-away portion of FIG. 11. The articulated segmented x-ray detector 200 may comprise a plurality of individual detectors 205a-205g that includes a semiconductor type x-ray detector section such as, e.g., section 161 (FIG. 3) which may be, e.g., a CMOS type or TFT type detector section. The plurality of individual detectors 205a-205g function in a similar manner as the plurality of individual detectors 105a-105g, described previously, but may be connected differently. The plurality of individual detectors 205a-205g may be configured to be connected to one another while also permitting the plurality of individual detectors 205a-205g to flexibly reposition themselves relative to one another to conform to a shape of a target object to be x-rayed. The individual detectors 205a-205g may be connected with the flexible mat 225 at each end by using a connecting mechanism 230. The connecting mechanism 230 may comprise, e.g., a screw, bolt or pin, or other connecting mechanism. The connecting mechanism 230 may pass though slot 126, a portion of one of the individual detectors 205a-205g and into a portion of an adjacent detector 205a-205g, as shown in FIGS. 11 and 12. The connecting mechanism 230 is configured to permit articulated movement of the plurality of individual detectors 205a-205g by permitting rotation or pivoting of the plurality individual detectors 205a-205g at the connecting pivot point. In this manner, one individual detector 205a-205g may overlap with an adjacent individual detectors 205a-205g so that there is a continuity of image coverage from one individual detector 205a-205g to an adjacent individual detector 205a-205g. The flexible mat 225 may be configured with the x-ray blocking object 168 in a similar manner as flexible mat 125, described previously, including the various patterns.

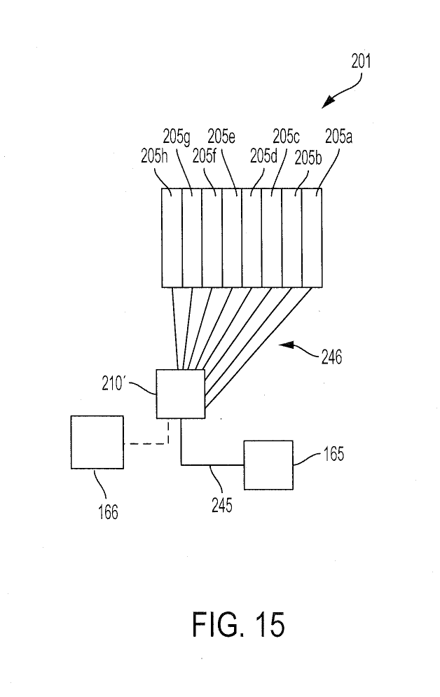

FIG. 11 also shows a camera controller 210 that may be configured to control the operations of the plurality of individual detectors 205a-205g, and receive image data. The camera controller 210 may be housed in a similar form factor as the detectors 205a-205g and may be a segment of the articulated segmented x-ray detector 200. Alternatively, the camera controller 210 may be an independent module separate from the articulated segmented x-ray detector 200, as shown in FIGS. 14 and 15. The camera controller 210 may comprise a control signal connector 110, a data signal connector 115 and a power connector 120. The camera controller 210 may also comprise a GPS unit 262 (FIG. 14) to record a location of the image that might be captured. In different implementations, the connectors may be reduced or increased depending on the type of communication links employed between the camera controller 210 and individual detectors 205a-205g (or 105a-105h). Preferably, a high bandwidth communication link may be utilized to permit the plurality of individual detectors 205a-205g (or 105a-105h) to download an image in real-time to the camera controller 210. The plurality of individual detectors 205a-205g (or 105a-105h) typically may not have memory for long-term storage of an image, therefore the image from each individual detector 205a-205g (or 105a-105h) may be sent to the camera controller 210. The camera controller 210 may receive the image data simultaneously or sequentially from each individual detector 205a-205g (or 105a-105h). The imaging may be directed and controlled by the camera controller 210. The high band width link may comprise, e.g., a USB3 link.

The camera controller 210 may include memory 260, a processor 261 and power 263 such as a battery (FIG. 14). The memory 260 may be configured to capture and store images from each of the plurality of individual detectors 205a-205g (or 105a-105h) for subsequent processing. In one aspect, the camera controller 210 may effectively act as a buffer of image data for eventual downloading as needed to another computer.

The articulated segmented x-ray detector 200 may include arms 215a, 215b at one end and a plurality of connectors 235 at the other end (one connector not shown). The arms 215a, 215b may be configured to permit connection of a connecting mechanism 220, such as, e.g., a rope, bungee cord, a collection of one or more magnetic connectors perhaps formed in the flexible mat 225, or the like, which can be wrapped around a target object 150 and connect to the connectors 235 for securing the articulated segmented x-ray detector 200 against the target object 150. The ability to quickly attach articulated segmented x-ray detector 200 (and similarly, articulated segmented x-ray detector 100) to or around a target object 150 allows for technicians to effectively and timely secure the articulated segmented x-ray detector 200 thereby making the overall imaging task more expedient, efficient and friendly.

In one aspect, the flexible mat 225 may include a plurality of slots 126, such as shown similarly in FIGS. 1 and 5, in raised wall portion(s) 123, to permit connecting mechanism 230 to slide laterally therewithin to permit the plurality of individual x-ray detector segments 205a-205h to move laterally to conform to a curvature or shape of the target object 150.

FIG. 13 is an example illustration showing a daisy-chain configuration among the plurality of individual detectors, configured according to principles of the disclosure. The plurality of individual detectors 205a-205g (or 105a-105h) may have the communication link that includes a data link and/or a control link connected in series 240 from one individual detector 205a-205g to another individual detector 205a-205g so that all of the plurality of individual detectors 205a-205g (or 105a-105h) are connected together. This configuration may employ left data connectors 110 and right data connectors 115 to convey image data from the individual detectors 105a-105h to the camera control box 210 when an image is taken. For example, data flow may flow into the left data connector 110 on a second detector 205a-205g from a right data connector 115 of a first individual detector 205a-205g. Alternatively, data may flow into the left data connector 110 on a first detector 205a-205g from the camera controller 210. The total bandwidth may be shared on a high speed communication link in the daisy-chain configuration. Data may pass through all the plurality of individual detectors 205a-205g (or 105a-105h) in this configuration. Each detector 205a-205g may utilize only a fraction of the total bandwidth of the communication link. A time division multiplexing technique may also be employed. The communication link may be, e.g., a USB3. The bandwidth may support 30 frames per second, or more. A control link 245 may interconnect the camera controller 210 with the x-ray source. This permits either the camera controller 210 or the x-ray source to signal the other for initiation of imaging. Alternatively, the plurality of individual detectors 205a-205g (or 105a-105h) may monitor for x-ray energy to initiate an exposure. The camera controller 210 may be configured to control the operation of each individual detector 205a-205g. The camera controller 210 may also supply power to each of the plurality of individual detectors 205a-205g (or 105a-105h). In one aspect, the camera controller 210 may be configured to perform basic image processing such as, e.g., flat field (gain and offset), averaging or adding of successive frames for data reduction purposes, high dynamic range frame, and the like. A computer 166 may be optionally connected to the camera controller 210 for receiving a download of image data. This may be over a wireless type connection. The computer 166 may be configured to perform post processing on the imaged data to reconstruct the image data from each of the plurality of individual detectors 205a-205g (or 105a-105h) to remove the stretching that may be present and to produce a final image of the target object 150 including any particulars associated with the target object such as, e.g., a weld joint. The computer 166 may be connected to a database for storing and retrieving image data. The computer 166 may be connected to a network for interconnection to other computers or a server. The camera controller 210 is described in more detail below.

FIG. 14 is an example illustration showing a parallel type configuration between the plurality of individual detectors and the camera controller, configured according to principles of the disclosure. The camera controller 210 may be connected by communication link 246 that may be a common bus architecture. The data flow may be bi-directional. The camera controller 210 may be configured with a memory 260, a processor 261 or a power supply 263, such as e.g., a battery 263. The camera controller 210 may be further configured with a global positioning system (GPS) unit 262. The GPS unit 262 may provide automatic dating and/or location capture for any image captured, which may be downloaded to computer 166 for subsequent use. This GPS information may be used to document where an imaging event occurred along with a date and time. The GPS unit 262 may be associated with the articulated segmented x-ray detector 200 (or 100) for capturing location data and/or timestamp of an imaging event.

This may improve record keeping and may be used to track images with specific target objects including, e.g., specific welds. The camera controller 210 may be a separate stand-alone device as shown in FIG. 14, or may be a segment configured to be a segment of the articulated segmented x-ray detector 200 as shown in FIGS. 11 and 13. A similar technique may be utilized for the articulated segmented x-ray detector 100.

FIG. 15 is an example illustration showing a star type configuration between the plurality of individual detectors and the camera controller, configured according to principles of the disclosure. The multiple connections 246 between the camera controller 210′ and the plurality of individual detectors 205a-305h creating the articulated segmented x-ray detector 201 may provide one or more of: control, data and power. The data flow may be bi-directional. A similar technique may be utilized for the articulated segmented x-ray detector 100.

The computer 166 (or, alternately, the camera controller 210) may be configured to perform image processing. This may include software such as, e.g., Sapera™ software from Teledyne Technologies Corporation. This image processing software may include one or more of the following functions:
Assemble a single High Dynamic range image from multiple frames (alternatively, may be performed in the camera controller 210).
Offset, Flatfield and Defect Correction including simplified user calibration (alternatively, may be performed in the camera controller 210).
X-ray noise management.
Edge detection and Enhancement.
Ability to detect motion and discard, register or stack multiple images to each other.
Real-time averaging in dynamic mode to show SNR is improving over time (alternatively, may be performed in the camera controller 210).
Automatically apply offset, gain and pixel correction (alternatively, may be performed in the camera controller 210).
Seamless exposure time/frame rate control (alternatively, may be performed in the camera controller 210).
Automatic adjustment for contrast.
Built-in filtering options (low pass, high pass, ADRC)
Over/under exposure indicator.
Save in different formats (png, tif, jpg, mpg, DICONDE and similar formats)
Recognition, compensation of stretching from multiple images for reconstruction.

The systems, apparatus and methods herein may be used to x-ray a wide range of target objects, including but not limited to: metal objects, pipelines and related welds, airplane wings, construction girders, boiler tanks, nuclear plant infrastructure and related welds, and similar types of objects that may be x-ray imaged. The system described herein is rugged and portable and easy to deploy. The simple attaching technique which may be as simple as, e.g., a bungee cord, is quick and effective to attach to a target object. The articulation of the individual x-ray segments permits a wide range of target objects to be quickly imaged. Software processing may compensate for any stretching of the images and permits correction of image geometry for construction of a final seamless composite image from the multiple individual images from the various individual x-ray detector segments.

Additionally, multiple sets of the plurality of individual detectors 205a-305h may be arranged in an N×N format (e.g., side by side, two or more rows of detectors) to create an even larger x-ray detector. This may necessitate a bigger flexible mat with corresponding x-ray blocking objects.

While the invention has been described in terms of examples, those skilled in the art will recognize that the invention can be practiced with modifications in the spirit and scope of the appended claims. These examples given above are merely illustrative and are not meant to be an exhaustive list of all possible designs, embodiments, applications or modifications of the invention. Features of one example may be employed with other examples.

1. A system for imaging a target object, comprising:
an articulated segmented x-ray detector comprising a plurality of individual x-ray detector segments articulately connected to one another;
a camera controller configured to be connected to each of the plurality of individual x-ray detector segments for communicating with and receiving image data from each individual x-ray detector segment; and
a x-ray source for producing x-rays to create an image of the target object at the articulated segmented x-ray detector.

2. The system of claim 1, wherein the plurality of individual x-ray detector segments are pivotally connected to an adjacent individual x-ray detector segment to permit rotation with respect to one another and to conform to a shape of the target object.

3. The system of claim 1, wherein the plurality of individual x-ray detector segments overlap.

4. The system of claim 1, wherein each of the plurality of individual x-ray detector segments comprises a semiconductor based detector.

5. The system of claim 1, further comprising a flexible mat configured to hold the articulated segmented x-ray detector against the target object.

6. The system of claim 5, wherein the flexible mat includes a plurality of x-ray blocking material arranged in a pattern.

7. The system of claim 6, wherein the plurality of x-ray blocking material is arranged at known locations with respect to one another for use in reconstructing images.

8. The system of claim 5, wherein the flexible mat includes a plurality of slots to permit a retaining mechanism to slide laterally to permit the plurality of individual x-ray detector segments to move to conform to a curvature of the target object.

9. The system of claim 1, wherein the camera controller and the plurality of individual x-ray detector segments are interconnected for at least one of: power, data and control.

10. The system of claim 9, wherein the camera controller and the plurality of individual x-ray detector segments are interconnected using one of: a serial connection, a daisy-chain connection, a star connection and a parallel connection.

11. The system of claim 1, wherein the camera controller receives image data from each the plurality of individual x-ray detector segments simultaneously or sequentially.

12. The system of claim 1, further comprising a computer connectable to the camera controller for receiving the image data for subsequent correction and reconstruction to produce a final corrected composite image of the target object.

13. The system of claim 1, further comprising a housing to house the articulated segmented x-ray detector, wherein at least a one side of the housing comprises a non-x-ray blocking material.

14. The system of claim 1, further comprising a GPS unit associated with the articulated segmented x-ray detector for capturing location data of an imaging event.

15. An apparatus for imaging an object, comprising:
an articulated segmented x-ray detector comprising a plurality of individual x-ray detector segments articulately connected to one another to permit rotation with respect to one another, wherein one individual x-ray segment overlaps with an adjacent individual x-ray segment; and
a camera controller configured to be connected to each of the plurality of individual x-ray detector segments for communicating with and receiving image data.

16. The apparatus of claim 15, further comprising a flexible mat connected to the articulated segmented x-ray detector and configured with a plurality of x-ray blocking objects for providing a reference in a captured image.

17. The apparatus of claim 15, wherein the plurality of individual x-ray detector segments each comprises a semiconductor based detector.

18. The apparatus of claim 15, wherein the camera controller is configured to be articulately connected to one of the individual x-ray detector segments.

19. A method of imaging a target object comprising the steps of:
connecting a plurality of individual x-ray detector segments to one another to create an articulated segmented x-ray detector, wherein the plurality of individual x-ray detector segments are rotatable with respect to one another;
connecting a camera controller to each of the plurality of individual x-ray detector segments for receiving image data from each individual x-ray detector segments; and
providing a x-ray source for producing x-rays to create an image of the target object at the articulated segmented x-ray detector.

20. The method system of claim 19, the connecting a plurality of individual x-ray detector segments step includes pivotally connecting at least one of the plurality of individual x-ray detector segments to an adjacent individual x-ray detector segment to permit rotation with respect to one another and for conforming to a shape of the target object.

21. The method of claim 20, wherein the connecting a plurality of individual x-ray detector segments step includes overlapping the plurality of individual x-ray detector segments.

22. The method of claim 19, wherein the plurality of individual x-ray detector segments each comprises a semiconductor detector.

23. The method of claim 22, wherein the plurality of individual x-ray detector segments comprises a CMOS detector or a TFT detector.

24. The method of claim 19, further comprising providing a flexible mat configured to hold the articulated segmented x-ray detector against the target object, the flexible mat including x-ray blocking objects to create reference points in the received image data.

25. The method of claim 24, wherein the flexible mat is configured to be held in place about the target object with a flexible connector or one or more magnets.

26. The method of claim 24, further comprising processing a received image data from each individual x-ray detector using the reference points in the received image data to compensate for any stretching or compressing in the received image data to create a final composite image.

27. The method of claim 19, wherein the step of connecting a camera controller to each of the plurality of individual x-ray detector segments permits communication between the camera controller and the plurality of individual x-ray detector segments including control data.
